(19) United States
(12) Patent Application Publication
(10) Pub. No.: US 2008/0042736 A1
(43) Pub. Date: Feb. 21, 2008

(54) Temperature dependent internal voltage generator

(75) Inventor: Sang-Jin Byeon, Kyoungki-do (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/647,236

(22) Filed: Dec. 29, 2006

(30) Foreign Application Priority Data
May 31, 2006 (KR) 2006-0049131

(51) Int. Cl. G05F 1/10

(52) U.S. Cl. 327/539

(57) ABSTRACT

A band-gap reference voltage generation device includes: a voltage generation unit for generating a first voltage and a second voltage, wherein the first voltage has a constant voltage level regardless of temperature variation, the second voltage has a positive (+) characteristic or a negative (+) characteristic according to temperature variation; and an internal reference voltage generation unit for selecting one of the first and the second voltages in order to generate at least one internal reference voltage which has a temperature characteristic of the selected voltage.

### CROSS-REFERENCE TO RELATED APPLICATION

The present invention claims priority of Korean patent application number 10-2006-0049131, filed on May 31, 2006, which is incorporated by reference in its entirety.

### BACKGROUND OF THE INVENTION

The present invention relates to an internal voltage generator included in a semiconductor device; and, more particularly, to a temperature dependent internal voltage generator.

As a semiconductor memory device is highly integrated and is operated at a higher speed and a lower voltage, an internal power supply voltage is needed to be generated in a dynamic random access memory (DRAM). For generating the internal power supply voltage, a reference voltage is generated and the generated reference voltage is charge pumped or down converted.

Typical internal power supply voltages generated by charge pumping are a boosted voltage VPP and a back bias voltage VBB. Likewise, a typical internal power supply voltage generated by down converting is a core voltage VCORE.

Generally, the boosted voltage VPP is generated in order to supply a gate of a cell transistor (or a word line) with a higher voltage than an external power supply voltage VDD so that a cell can be accessed without data loss.

The back bias voltage VBB is generated in order to supply a bulk of the cell transistor with a lower voltage than an external ground voltage VSS so that data loss of a cell can be prevented.

The core voltage VCORE is generated by down converting the external power supply voltage VDD for reducing power consumption and for stable core operation. Herein, the core voltage VCORE is generated by using an amplifier, e.g., an operational amplifier, so that the core voltage VCORE is lower than the external power supply voltage VDD and has a constant voltage level within an operation period when the external power supply voltage. VDD is varied.

FIG. 1 is a block diagram of a conventional internal voltage generator.

Referring to FIG. 1, a process of generating an internal power supply voltage according to the conventional internal voltage generator is described below.

Voltage generation unit 10 is a band-gap circuit that generates an output voltage VBG which has a constant voltage level regardless of a variation of process, voltage and temperature (PVT).

In response to the output voltage VBG, reference voltage generation unit 20 generates a boost reference voltage VREFP, a back bias reference voltage VREFB and a core reference voltage VREFC which are needed for generating a boosted voltage VPP, a back bias voltage VBB and a core voltage VCORE respectively.

In response to the boost reference voltage VREFP and the back bias reference voltage VREFB, an internal voltage pumping operation is performed through a voltage detector, an oscillator, a pump controller and a pump in order to generate the boosted voltage VPP and the back bias voltage VBB. The core voltage VCORE is generated by using a core voltage generator.

FIG. 2 is a schematic circuit diagram illustrating the voltage generation unit 10 shown in FIG. 1.

Referring to FIG. 2, the voltage generation unit 10 includes vertical PNP bipolar junction transistors Q1 and Q2 whose variation is small during a manufacturing process.

By using temperature characteristics of a bipolar junction transistor, a PTAT (proportional to absolute temperature) term (IPTAT, M*IPTAT) where an electric current is increased as a temperature increases and a CTAT (complementary proportional to absolute temperature) term (ICTAT, K*ICTAT) where an electric current is decreased as a temperature increases are generated. By combination of the PTAT term and the CTAT term, the output voltage VBG which has a constant voltage level according to the PVT variation is generated.

According to analysis of the schematic circuit, since a node A and a node B are virtually shorted by an operational amplifier op-ampl, equations of a ratio of a general diode current to voltage are shown below. Herein, the diode current is represented by a base-emitter current of the two bipolar junction transistors Q1 and Q2 which have a ratio of 1:N.

$$\begin{matrix}{I}_{Q} = {I}_{S} ( exp [ \frac{{V}_{BE}}{{V}_{T}} ] - 1 ) \approx {I}_{S} exp [ \frac{{V}_{BE}}{{V}_{T}} ] {V}_{SE} >> {V}_{T} & [ Eq . 1 ] \\ {I}_{Q 1} = {I}_{S} exp [ \frac{{V}_{BE 1}}{{V}_{T}} ] & [ Eq . 2 ] \\ {I}_{Q 2} = N \cdot {I}_{S} exp [ \frac{{V}_{BE 2}}{{V}_{T}} ] & [ Eq . 3 ]\end{matrix}$$

Herein; I_{Q1} and I_{Q2} are base-emitter currents flowing in the bipolar junction transistors Q1 and Q2 respectively. Therefore, when a voltage of the node A is equal to that of the node B, IPTAT current flowing through resistor R1 is expressed as shown below.

$${I}_{PTAT} = \frac{( {V}_{BE 1} - {V}_{BE 2} )}{R 1} = \frac{ln ( N \cdot α ) \cdot {V}_{T}}{R 1} \qquad [ Eq . 4 ]$$

Under the same condition, ICTAT current flowing through resistor R2 is expressed as follows.

$${I}_{CTAT} = \frac{{V}_{BE 1}}{R 2} \qquad [ Eq . 5 ]$$

On the assumption that a same current is flowing on a same sized p-type metal oxide semiconductor (PMOS) transistor, P5 current is proportional to P1 current.

I₅=M·I_{PTAT} [Eq. 6]

On the same assumption, P4 current is proportional to P3 current.

I₄=K·I_{CTAT} [Eq. 7]

Therefore, P4 current and P5 current are respectively K*ICTAT and M*IPTAT. A calculated output voltage VBG is as follows.

$$VBG = \frac{K \cdot {R}_{3}}{{R}_{2} \cdot ( {V}_{BE 1} + ( \frac{M \cdot {R}_{2}}{K \cdot {R}_{1}} ) ln ( N \cdot α ) \cdot {V}_{T} )} \qquad [ Eq . 8 ]$$

If values of N, R1, R2, R3, K and M are appropriately adjusted for temperature compensation, the output voltage VBG has a constant voltage level according to the PVT variation. Generally, values of N, R1, R2 and R3 are fixed and values of K and M are adjusted in order to adjust current amount of the PTAT term and the CTAT term.

FIG. 3 is a diagram depicting voltage variations of the internal power supply voltages generated by the conventional internal voltage generator according to temperature variation.

Referring to FIG. 3, the boosted voltage VPP, the back bias voltage VBB and the core voltage VCORE have a constant voltage level according to temperature variation.

However, if an internal power supply voltage always keeps a constant voltage level regardless of temperature variation, a write recovery time (tWR) is increased at a low temperature because a threshold voltage (Vth) of a transistor is increased as temperature decreases. Likewise, since leakage current is increased at a high temperature, a refresh time is decreased.

### SUMMARY OF THE INVENTION

Embodiments of the present invention are directed to provide a band-gap reference voltage generation device for generating an internal reference voltage whose voltage level has a constant voltage level or is increased or decreased according to temperature variation.

In accordance with an aspect of the present invention, there is provided a band-gap reference voltage generation device, including: a voltage generation unit for generating a first voltage and a second voltage, wherein the first voltage has a constant voltage level regardless of temperature variation, the second voltage has a positive (+) characteristic or a negative (−) characteristic according to temperature variation; and an internal reference voltage generation unit for selecting one of the first and the second voltages in order to generate at least one internal reference voltage which has a temperature characteristic of the selected voltage.

In accordance with another aspect of the present invention, there is provided a semiconductor device, including: a voltage generation unit for generating a first voltage and a second voltage, wherein the first voltage has a constant voltage level regardless of temperature variation, the second voltage has a positive (+) characteristic a negative (−) characteristic according to temperature variation; an internal reference voltage generation unit for selecting one of the first and the second voltages in order to generate at least one internal reference voltage which has a temperature characteristic of the selected voltage; and an internal power supply voltage generation unit for generating at least one internal power supply voltage in response to the internal reference voltage.

In accordance with a further another aspect of the present invention, there is provided a semiconductor device, including: a voltage generation unit for generating a first voltage and a second voltage, wherein the first voltage has a constant voltage level regardless of temperature variation, the second voltage has a positive (+) characteristic a negative (−) characteristic according to temperature variation; a control voltage generation unit for selecting one of the first and the second voltages in order to generate at least one period control signal which has a temperature characteristic of the selected voltage; and a self refresh signal generation unit for generating a self refresh signal by oscillating in response to the period control signal.

### BRIEF DESCRIPTION OF THE DRAWINGS

FIG. 1 is a block diagram of a conventional internal voltage generator.

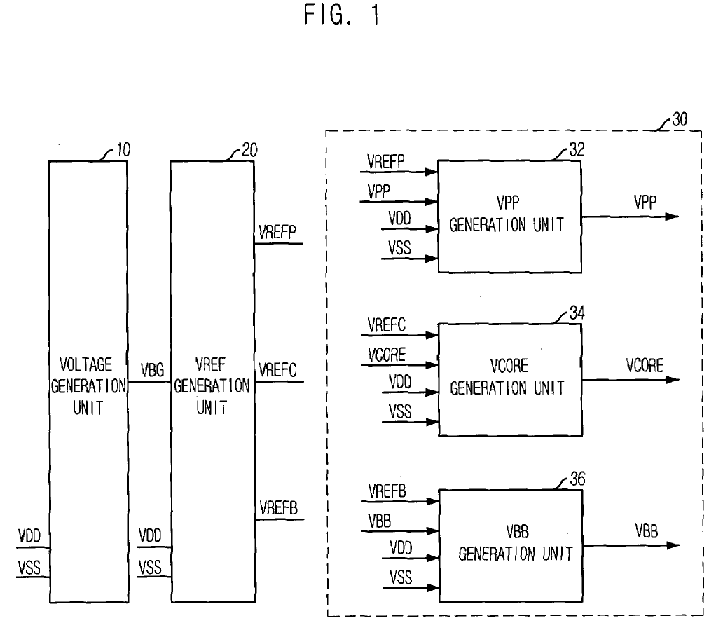

FIG. 2 is a schematic circuit diagram of the voltage generation unit shown in FIG. 1.

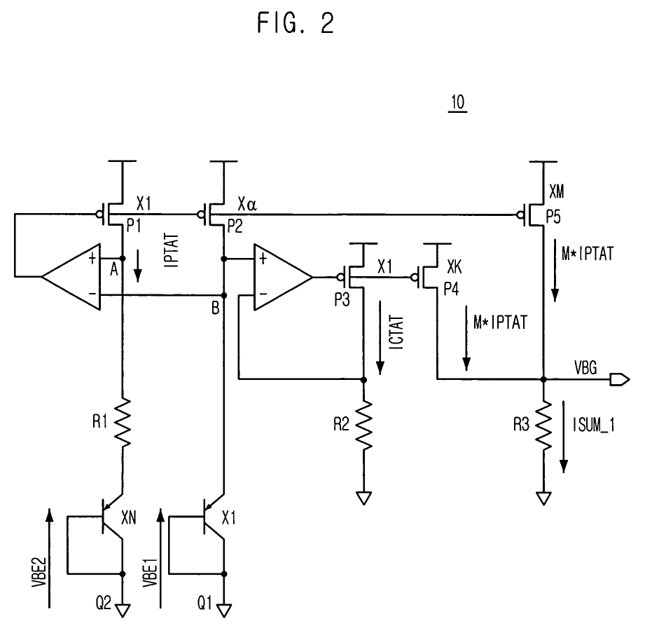

FIG. 3 is a diagram depicting voltage variations of the internal power supply voltages generated by the conventional internal voltage generator according to temperature variation.

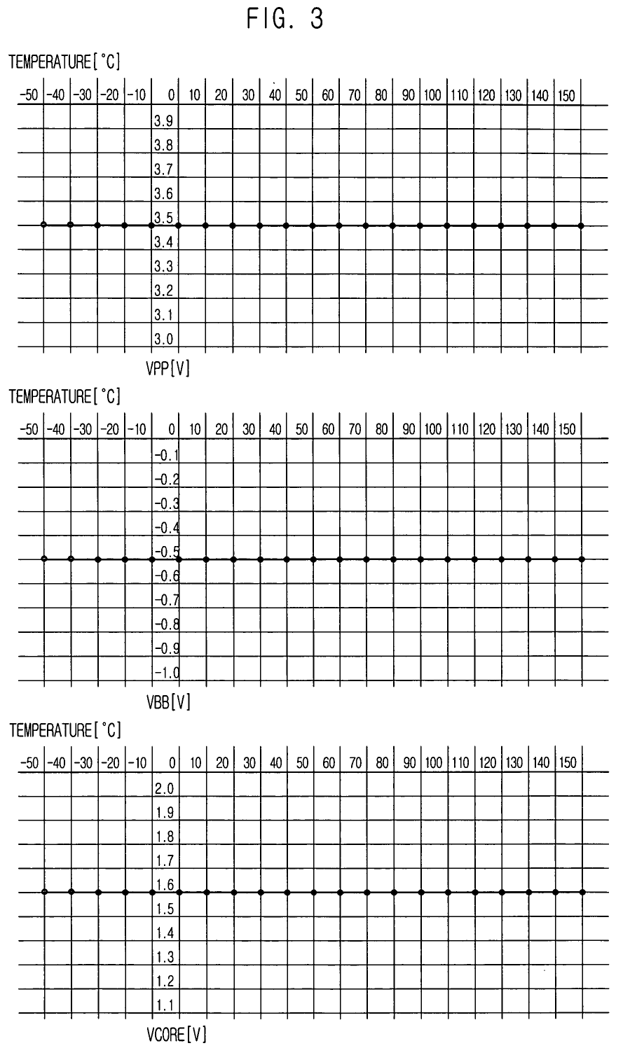

FIG. 4 is a block diagram of a process of generating an internal reference voltage in accordance with a preferred embodiment of the present invention.

FIG. 5 is a schematic circuit diagram of the voltage generation unit shown in FIG. 4.

FIG. 6 is a schematic circuit diagram of the core reference voltage generation unit shown in FIG. 4.

FIG. 7 is a block diagram of a process of generating an internal power supply voltage by using the generated internal reference voltage in accordance with the preferred embodiment of the present invention.

FIG. 8 is a diagram showing voltage level variations of the internal power supply voltages according to temperature variation.

### DESCRIPTION OF SPECIFIC EMBODIMENTS

It is an object of the present invention to provide a band-gap reference voltage generation device for generating an internal reference voltage whose voltage level has a constant voltage level or is increased or decreased according to temperature variation. Therefore, since an internal power supply voltage can be varied depending on temperature variation, a margin of a semiconductor device for temperature variation can be secured.

Hereinafter, an internal voltage generator in accordance with the present invention will be described in detail referring to the accompanying drawings.

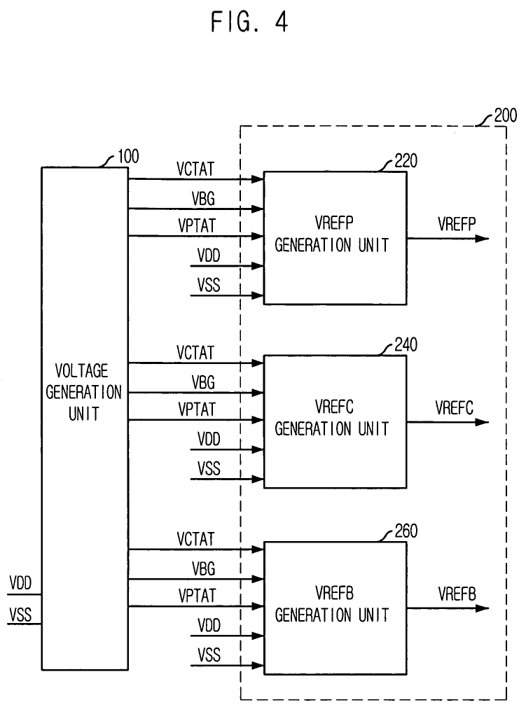

FIG. 4 is a block diagram of a process of generating an internal reference voltage in accordance with a preferred embodiment of the present invention.

Referring to FIG. 4, the internal voltage generator includes a voltage generation unit 100 for generating a first voltage VBG, a second voltage VPTAT and a third voltage VCTAT; and an internal reference voltage generation unit 200 for selecting one of the first to the third voltages VBG to VCTAT in order to generate at least one internal reference voltage, e.g., a boost reference voltage VREFP, a core reference voltage VREFC and a back bias reference voltage VREFB, which has a temperature characteristic of the selected voltage. Herein, the first voltage VBG has a constant voltage level regardless of temperature variation; the second voltage VPTAT has a positive (+) characteristic according to temperature variation; the third voltage VCTAT has a negative (−) characteristic according to temperature variation.

Further, the internal reference voltage generation unit 200 includes at least one reference voltage generation unit, e.g., 220, 240 and 260, according to the internal reference voltages VREFP, VREFC and VREFB. Although each of the reference voltage generation units 220 to 260 has the same circuit structure, the internal reference voltages VREFP, VREFC and VREFB generated by the reference voltage generation units 220 to 260 have different temperature characteristics (VCTAT, VPTAT, VBG) and different voltage levels.

That is, the generated internal reference voltage has a characteristic selected among a constant voltage level regardless of temperature variation, a positive (+) characteristic according to temperature variation and a negative (−) characteristic according to temperature variation. Herein, the positive (+) characteristic means that a voltage level is proportional to temperature variation, i.e., a voltage level is increased as temperature increases. Likewise, the negative (−) characteristic means that a voltage level is inversely proportional to temperature variation, i.e., a voltage level is decreased as temperature increases.

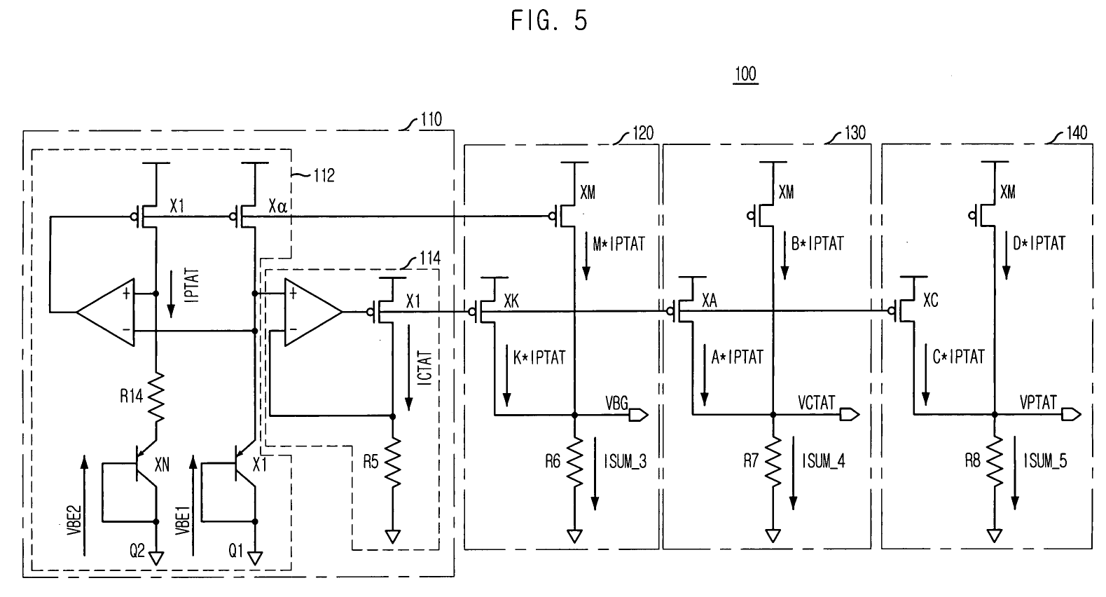

FIG. 5 is a schematic circuit diagram depicting the voltage generation unit 100 shown in FIG. 4.

As shown, the voltage generation unit 100 includes a current generation unit 110, a first voltage generation unit 120, a second voltage generation unit 140 and a third voltage generation unit 130.

The current generation unit 110 generates a first current IPTAT which has a positive (+) characteristic according to temperature variation and a second current ICTAT which has a negative (−) characteristic according to temperature variation. The first voltage generation unit 120 generates the first voltage VBG which has a constant voltage level regardless of temperature variation in proportion to a third current ISUM_3, wherein the third current ISUM_3 is generated by mixing the first current IPTAT and the second current ICTAT in a constant ratio, i.e., K*IPTAT:M*ICTAT.

The second voltage generation unit 140 generates the second voltage VPTAT which has a positive (+) characteristic according to temperature variation in proportion to a fourth current ISUM_4, wherein the fourth current ISUM_4 is generated by mixing the first current IPTAT and the second current ICTAT in a constant ratio, i.e., B*IPTAT:A*ICTAT. The third voltage generation unit 130 generates the third voltage VCTAT which has a negative (−) characteristic according to temperature variation in proportion to a fifth current ISUM_5, wherein the fifth current ISUM_5 is generated by mixing the first current IPTAT and the second current ICTAT in a constant ratio, i.e., D*IPTAT:C*ICTAT.

The current generation unit 110 includes a first current generation unit 112 and a second current generation unit 114.

The first current generation unit 112 generates the first current IPTAT by supplying a fourth resistor R4 with a second base-emitter voltage VBE2 which is proportional to a second emitter current IE2 of a second bipolar transistor Q2. The second emitter current IE2 is N times larger than a first emitter current IE1 of a first bipolar transistor Q1. The second current generation unit 114 generates the second current ICTAT by supplying a fifth resistor R5 with a first base-emitter voltage VBE1 which is proportional to the first emitter current IE1. The second current generation unit 114 is connected to the first current generation unit 112 in a cascade form.

The first voltage generation unit 120 supplies a sixth resistor R6 with the third current ISUM_3 generated by adding a current (M*IPTAT) which is M times larger than the first current IPTAT to a current (K*ICTAT) which is K times larger than the second current ICTAT to thereby generate the first voltage VBG. The second voltage generation unit 140 supplies an eighth resistor R8 with the fifth current ISUM_5 generated by adding a current (D*IPTAT) which is D times larger than the first current IPTAT to a current (C*ICTAT) which is C times larger than the second current ICTAT to thereby generate the second voltage VPTAT. The third voltage generation unit 130 supplies a seventh resistor R7 with the fourth current ISUM_4 generated by adding a current (B*IPTAT) which is B times larger than the first current IPTAT to a current (A*ICTAT) which is A times larger than the second current ICTAT to thereby generate the third voltage VCTAT.

Although the second and the third voltage generation units 140 and 130 have the same structure as the first voltage generation unit 120, each voltage level of the second and the third voltages VPTAT and VCTAT is changed according to temperature variation because there is a driving strength difference among PMOS transistors (P4<->P6<->P8, P5<->P7<->P9)

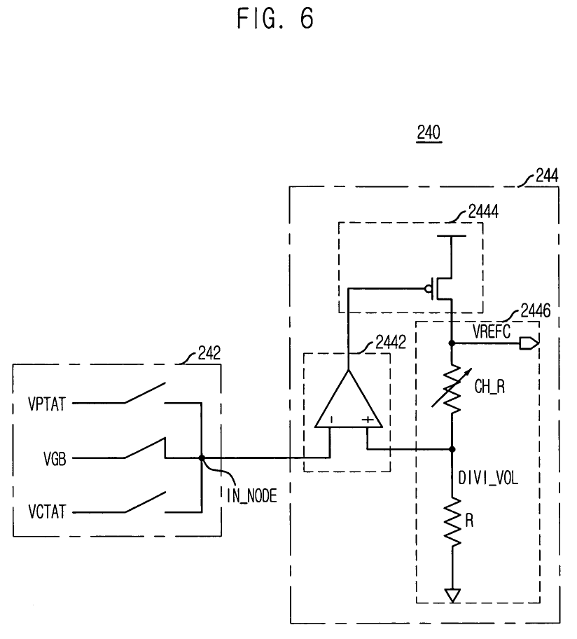

FIG. 6 is a schematic circuit diagram of the core reference voltage generation unit 240 shown in FIG. 4.

Referring to FIG. 6, the core reference voltage generation unit 240 includes an option process unit 242 and an internal voltage output unit 244.

An option process unit 242 selects one of the first to the third voltages VBG to VCTAT and transfers the selected voltage to an input node IN_NODE in response to a selected option. The internal voltage output unit 244 generates an internal reference voltage (in this case, VREFC) which has the same temperature characteristic as the voltage loaded on the input node IN_NODE.

The internal voltage output unit 244 includes a comparing unit 2442, a driving unit 2444 and a dividing unit 2446.

The comparing unit 2442 compares the voltage loaded on the input node IN_NODE with a divided voltage DIVI_VOL. The driving unit 2444 drives the internal reference voltage in response to an output signal of the comparing unit 2442. The dividing unit 2446 includes a variable resistor CH_R and a fixed resistor R connected in series between an internal reference voltage output terminal and a ground voltage terminal in order to generate the divided voltage DIVI_VOL at a connection node between the variable resistor CH_R and the fixed resistor R.

The dividing unit 2446 determines the internal reference voltage by adjusting a resistance of the variable resistor CH_R.

That is, the internal reference voltage generation unit 200 applies one of the first to the third voltages VBG to VCTAT which have a different temperature characteristic to generating the internal reference voltage. For instance, by applying the second voltage VPTAT, a core voltage VCORE is generated and a voltage level of the generated core voltage VCORE is increased as temperature increases.

Therefore, in accordance with the present invention, one of a voltage whose voltage level is constant according to temperature variation, a voltage whose voltage level is increased according to temperature variation and a voltage whose voltage level is decreased according to temperature variation is selected to generate an internal reference voltage, and thus, a margin of a semiconductor device can be increased. For instance, at a low temperature, by increasing an absolute value of the boosted voltage VPP and decreasing an absolute value of the back bias voltage VBB, a margin for preventing a tWR fail can be secured and, thus, a production yield can be increased. Likewise, at a high temperature, by increasing an absolute value of the back bias voltage VBB, a refresh time is increased and, thus, a power consumption can be reduced.

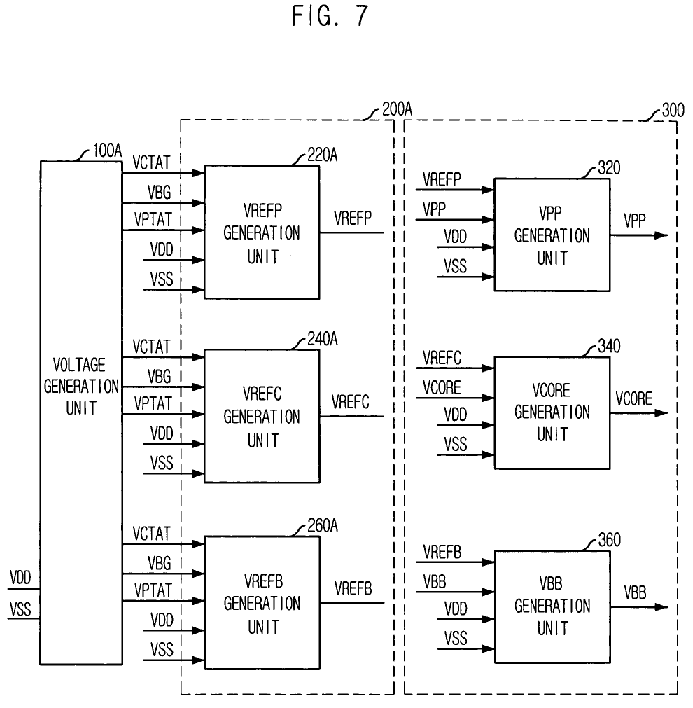

FIG. 7 is a block diagram showing a process of generating an internal power supply voltage by using the generated internal reference voltage in accordance with the preferred embodiment of the present invention.

Referring to FIG. 7, the internal voltage generator further includes an internal power supply voltage generation unit 300 for generating an internal power supply voltage, e.g., VPP, VCORE and VBB, by using the internal reference voltage, e.g., VREFP, VREFC and VREFB, generated by the internal reference voltage generation unit 200.

The internal power supply voltage unit 300 includes at least one power supply voltage generation unit, e.g., a boosted voltage generation unit 320, a core voltage generation unit 340 and a back bias voltage generation unit 360, according to a kind of the internal power supply voltage. Each of the power supply voltage generation units has a different structure to provide a generated internal power supply voltage.

In accordance with the preferred embodiment of the present invention, the internal power supply voltage unit 300 includes the boosted voltage generation unit 320 for generating the boosted voltage VPP; the core voltage generation unit 340 for generating the core voltage VCORE; and the back bias voltage generation unit 360 for generating the back bias voltage VBB.

The internal voltage generator 200A generates the boost reference voltage VREFP, the core reference voltage VREFC and the back bias reference voltage VREFB for respectively generating the boosted voltage VPP, the core voltage VCORE and the back bias voltage VBB. However, the preferred embodiment of the present invention can be used in order to generate internal reference voltages for generating all the internal power supply voltages used in a semiconductor device.

The present invention also can be applied to any circuit which uses a reference voltage required to be temperature compensated. For instance, the present invention can be applied to a self refresh period control device which changes a self refresh period according to temperature variation.

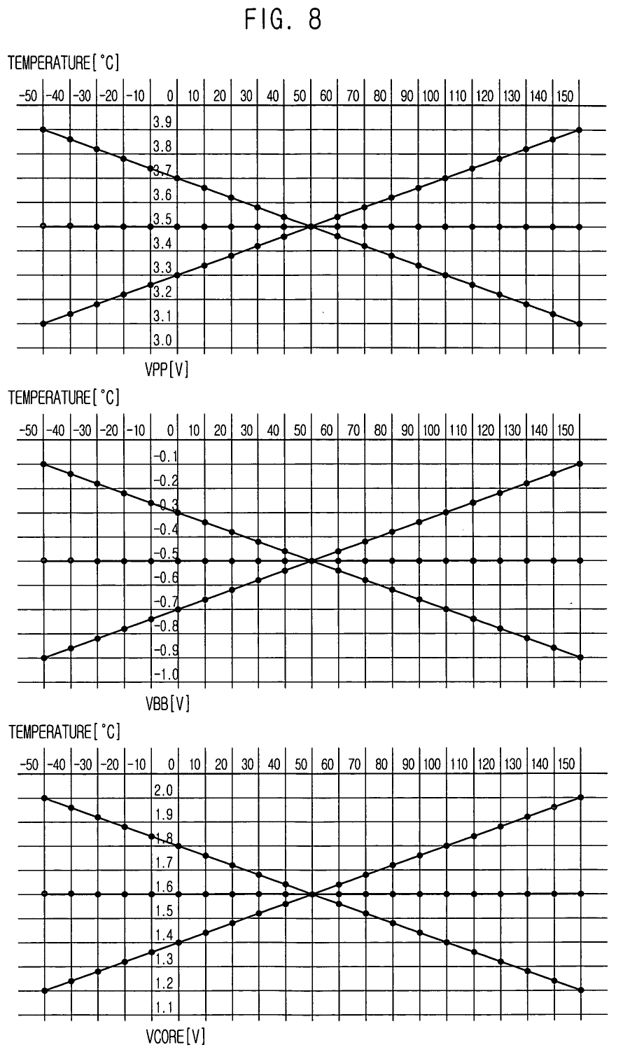

FIG. 8 is a diagram showing voltage level variations of the internal power supply voltages according to temperature variation.

As shown, the internal power supply voltages VPP, VCORE and VBB have a constant voltage level according to temperature variation, or increase according to temperature increase, or decrease according to temperature increase.

While the present invention has been described with respect to the specific embodiments, it will be apparent to those skilled in the art that various changes and modifications may be made without departing from the spirit and scope of the invention as defined in the following claims.

What is claimed is:

1. A band-gap reference voltage generation device, comprising:
a voltage generation unit for generating a first voltage and a second voltage, wherein the first voltage has a constant voltage level regardless of temperature variation, the second voltage has a positive (+) characteristic or a negative (−) characteristic according to temperature variation; and
an internal reference voltage generation unit for selecting one of the first and the second voltages.

2. The band-gap reference voltage generation device as recited in claim 1, wherein the voltage generation unit includes:
a current generation unit for generating a first current and a second current which respectively have a positive (+) characteristic and a negative (−) characteristic according to temperature variation;
a first voltage generation unit for generating the first voltage which has a constant voltage level in proportion to a third current, wherein the third current is generated by mixing the first and the second currents in a constant ratio; and
a second voltage generation unit for generating the second voltage which has a positive (+) characteristic or a negative (−) characteristic according to temperature variation in proportion to a fourth current, wherein the fourth current is generated by mixing the first and the second currents in a constant ratio.

3. The band-gap reference voltage generation device as recited in claim 2, wherein the current generation unit includes:
a first current generation unit for generating the first current by supplying a fourth resistor with a second base-emitter voltage which is proportional to a second emitter current of a second bipolar transistor, wherein the second emitter current is constant number times larger than a first emitter current of a first bipolar transistor; and
a second current generation unit connected to the first current generation unit in a cascade form for generating the second current by supplying a fifth resistor with a first base-emitter voltage which is proportional to the first emitter current.

4. The band-gap reference voltage generation device as recited in claim 2, wherein the first voltage generation unit generates the first voltage by supplying a sixth resistor with the third current, wherein the third current is generated by mixing a current which is M times larger than the first current and a current which is K times larger than the second current.

5. The band-gap reference voltage generation device as recited in claim 2, wherein the second voltage generation unit generates the second voltage by supplying an eighth resistor with the fourth current, wherein the fifth current is generated by mixing a current which is D times larger than the first current and a current which is C times larger than the second current.

6. The band-gap reference voltage generation device as recited in claim 1, wherein the internal reference voltage generation unit includes at least one reference voltage generation unit according to a kind of the internal reference voltage, wherein each reference voltage generation unit has a same circuit structure and has a different temperature characteristic and a different voltage level according to an option.

7. The band-gap reference voltage generation device as recited in claim 6, wherein the internal reference voltage generation unit includes:
an option process unit for selecting one of the first to the third voltages in response to the option and for transferring the selected voltage to an input node; and
an internal reference voltage output unit for generating the internal reference voltage which has the same temperature characteristic as a voltage loaded on the input node.

8. The band-gap reference voltage generation device as recited in claim 7, wherein the internal reference voltage output unit includes:
a comparing unit for comparing the voltage loaded on the input node and a divided voltage;
a driving unit for driving the internal reference voltage in response to an output signal of the comparing unit; and
a dividing unit having a variable resistor and a fixed resistor connected in series between the internal reference voltage and a ground voltage for generating the divided voltage at a connection node between the variable resistor and the fixed resistor.

9. The band-gap reference voltage generation device as recited in claim 8, wherein the dividing unit determines a kind of the internal reference voltage by adjusting a resistance of the variable resistor.

10. A semiconductor device, comprising:
a voltage generation unit for generating a first voltage and a second voltage, wherein the first voltage has a constant voltage level regardless of temperature variation, the second voltage has a positive (+) characteristic or a negative (−) characteristic according to temperature variation;
an internal reference voltage generation unit for selecting one of the first and the second voltages in order to generate at least one internal reference voltage which has a temperature characteristic of the selected voltage; and
an internal power supply voltage generation unit for generating at least one internal power supply voltage in response to the internal reference voltage.

11. The semiconductor device as recited in claim 10, wherein the internal power supply voltage generation unit includes at least one power supply voltage generation unit, wherein each power supply voltage generation unit has a different circuit structure according to the internal power supply voltage.

12. The semiconductor device as recited in claim 11, wherein the internal power supply voltage generation unit includes:
a boosted voltage generation unit for generating a boosted voltage;
a core voltage generation unit for generating a core voltage; and
a back bias voltage generation unit for generating a back bias voltage.

13. The semiconductor device as recited in claim 12, wherein the internal reference voltage generation unit selects one of the first and the second voltages and generates a first reference voltage which has a temperature characteristic of the selected voltage, wherein the first reference voltage is used by the boosted voltage generation unit for generating the boosted voltage.

14. The semiconductor device as recited in claim 12, wherein the internal reference voltage generation unit selects one of the first and the second voltages and generates a second reference voltage which has a temperature characteristic of the selected voltage, wherein the second reference voltage is used by the core voltage generation unit for generating the core voltage.

15. The semiconductor device as recited in claim 12, wherein the internal reference voltage generation unit selects one of the first and the second voltages and generates a third reference voltage which has a temperature characteristic of the selected voltage, wherein the third reference voltage is used by the back bias voltage generation unit for generating the back bias voltage.

16. A semiconductor device, comprising:
a voltage generation unit for generating a first voltage and a second voltage, wherein the first voltage has a constant voltage level regardless of temperature variation, the second voltage has a positive (+) characteristic or a negative (−) characteristic according to temperature variation;
a control voltage generation unit for selecting one of the first and the second voltages in order to generate at least one period control signal which has a temperature characteristic of the selected voltage; and
a self refresh signal generation unit for generating a self refresh signal by oscillating in response to the period control signal.
